(19) United States
(12) Patent Application Publication
(10) Pub. No.: US 2017/0015345 A1
(43) Pub. Date: Jan. 19, 2017

(54) STEERING COLUMN FOR A MOTOR VEHICLE

(71) Applicants: ThyssenKrupp Presta AG, Eschen (LI); ThyssenKrupp AG, Essen (DE)

(72) Inventor: Robert GALEHR, Schuanwald (LI)

(73) Assignees: ThyssenKrupp Presta AG, Eschen (IL); ThyssenKrupp AG, Essen (DE)

(21) Appl. No.: 15/124,239

(22) PCT Filed: Feb. 25, 2015
(86) PCT No.: PCT/EP2015/053954

§ 371 Date: Sep. 7, 2016

(30) Foreign Application Priority Data
Mar. 7, 2014 (DE) 10 2014 103 028.1

(51) Int. Cl. B62D 1/181; B62D 1/187

(52) U.S. Cl. CPC B62D 1/181; B62D 1/187; F16H 25/2015

(57) ABSTRACT

A steering column of a motor vehicle includes a supporting unit that is connectable to the chassis of the motor vehicle, an adjusting unit coupled to the supporting unit, a steering spindle disposed and rotatable supported in the adjusting unit, and an adjustment drive coupled between the supporting unit and the adjusting unit and configured to adjust a position of the adjusting unit in relation to the supporting unit. The adjustment drive includes a spindle nut having internal threads, an threaded rod having external threads in engagement with the internal threads of said spindle nut, and an end stop disposed at a first end of said threaded rod. The end stop is formed by a sleeve pressed onto the external threads of the threaded rod and is configured to limit an axial movement of said spindle nut along a length of the threaded rod.

### TECHNICAL FIELD

The present invention relates to a steering column for a motor vehicle, which comprises a supporting unit which is connectable to the chassis of the motor vehicle, and an adjustment unit which is held on the said supporting unit and is adjustable in relation to the supporting unit by means of an adjustment drive.

### PRIOR ART

Steering columns for motor vehicles are known, which comprise a supporting unit which is connectable to the chassis of the motor vehicle, for example in the form of bracket parts, and an adjusting unit which is held on the said supporting unit and is adjustable in relation to said supporting unit. The adjusting unit supports a steering spindle which serves for introducing a steering movement from a steering wheel into a steering system in order to transmit the steering movement to a steerable wheel.

It is known to design such an adjusting unit to be adjustable in relation to the supporting unit by means of an adjustment drive in order to be able to adapt the position of a steering wheel held on the steering spindle to the respective seat position of a driver of the motor vehicle. It is known in this connection to provide adjustability of the adjusting unit in the axial direction with respect to the steering spindle in order to achieve a longitudinal adjustment of the steering spindle. It is furthermore known to enable a height adjustment of the steering wheel by pivoting the adjusting unit in relation to the supporting unit.

Known adjustment drives comprise electric motors, by means of which a convenient adjustment of the adjusting unit in relation to the supporting unit can be achieved and which also enable the repeated starting up of previously stored positions if more than one driver operates the motor vehicle.

In the case of electrically adjustable steering columns for motor vehicles, it is necessary to convert the rotation of an output shaft of an electric motor into a translatory adjustment movement for adjusting the adjusting unit in relation to the supporting unit. This customarily takes place by means of a threaded rod drive which comprises a worm shaft arranged on the output of the electric motor and a spindle nut which is designed from the outer side as a worm wheel in the toothing of which the worm shaft arranged on the output shaft of the electric motor engages. By rotation of the positionally fixed spindle nut, the threaded rod is moved axially. In order to ensure a defined adjustment range of the steering column, a mechanical end stop is provided on the threaded rod. In an analogous manner, the threaded rod can also be rotated and, in the process, a spindle nut locked in the direction of rotation can be displaced axially.

AT 511962 A4 discloses a steering column for a motor vehicle, in which both a displacement of the steering spindle and a pivoting of the steering spindle in relation to a supporting unit can be undertaken in order to achieve an appropriate positioning of the steering wheel held on the steering spindle. The two adjustment movements, i.e. both the displacement and the pivoting, are achieved via a respective spindle drive. The spindle drives each comprise a threaded rod which is held via a spindle nut on one of the two units which are adjustable in relation to each other. The spindle nut is mounted in a positionally fixed manner and can be rotated via a drive motor with a worm shaft, which acts on an external toothing of the spindle nut, in order, via an internal thread which engages with the threaded rod, correspondingly to achieve a translation movement of the threaded rod with respect to the spindle nut in the direction of the threaded spindle axis. The translation movement of the threaded rod results in the adjustment movement of the adjusting unit.

DE 43 44 681 A1 discloses an electrically adjustable steering column in which a mechanical end stop of an adjustment spindle drive takes place with a disk which is mounted on a mechanically reworked end region of the adjustment spindle.

### SUMMARY OF THE INVENTION

Starting from the known prior art, it is an object of the present invention to specify a steering column for a motor vehicle, which permits a further simplified design and flexible use.

This object is achieved by a steering column for a motor vehicle having the features of Claim 1. Advantageous developments emerge from the dependent claims.

Accordingly, a steering column for a motor vehicle is proposed, comprising a supporting unit which is connectable to the chassis of the motor vehicle, and an adjusting unit which is held on said supporting unit and rotatably supports a steering spindle, wherein the position of the adjusting unit in relation to the supporting unit is adjustable by means of an adjustment drive, and the adjustment drive comprises a threaded rod having an external thread which is engagement with an internal thread of a spindle nut of the adjustment drive, and wherein the threaded rod comprises an end stop for limiting the movement of the spindle nut along the threaded rod. According to the invention, the end stop is formed by a sleeve pressed onto the external thread of the threaded rod. The sleeve and threaded rod are preferably connected here by means of a longitudinal press fit.

Owing to the fact that the end stop is formed by a sleeve pressed onto the external thread of the threaded rod, additional processing of the threaded rod prior to the mounting of the end stop is unnecessary. The threaded rod can therefore also be a threaded rod which is simply cut to size from a longer threaded rod and which has not been processed further. In particular, processing of the end region of the threaded rod, for example by turning or forming, in order to mount the end stop is not necessary. On the contrary, the sleeve forming the end stop can be pressed directly onto the external thread of the threaded rod, and therefore processing of the threaded rod is unnecessary.

The end stop is furthermore completely independent of the respective thread pitch of the external thread, and therefore the end stop in the form of the pressed-on sleeve is universally useable for any threaded rods of the abovementioned type.

The inside diameter of the sleeve when not pressed on is preferably smaller than the nominal diameter of the external thread. In this manner, a fixed and reliable pressing on of the sleeve can be achieved and accordingly a reliable end stop can be obtained making it possible for the adjustment to be blocked.

The sleeve can be pressed on under elastic deformation of the sleeve. The sleeve is preferably pressed onto the threaded rod under plastic deformation since the maximum resistance force against a longitudinal displacement of the sleeve on the threaded rod is achieved here.

By the sleeve being pressed onto the threaded rod, a secure fit of the sleeve at any point along the external thread of the threaded rod can be achieved. The end stop can therefore be adapted flexibly to the respective circumstances of the steering column, and therefore the end stop can be used modularly for a multiplicity of different steering columns or a multiplicity of different configurations of a steering column and the adjustment range thereof.

The sleeve is preferably pressed on in the direction of the axis of the threaded rod. This results in the sleeve being pressed particularly firmly on the external thread of the threaded rod. In an alternative, the sleeve can also be pressed onto the threaded rod during a screwing-on process by executing a rotation movement. By this means, a structure similar to the external thread of the threaded rod can be impressed in the material of the sleeve, said structure then leading to even greater stability of the end stop on the threaded rod. However, a thread is only impressed in the sleeve if the feed motion and the rotation speed during the pressing-on of the sleeve is also matched to the respective pitch of the external thread. However, this is not necessary for the formation of a fixed connection between the sleeve and the threaded rod.

The sleeve is preferably positionable freely on the threaded rod, and therefore the sleeve, depending on requirements, can be mounted at the required end stop position in the respective motor vehicle or, depending on requirements, on the threaded rod. The pressed on sleeve proposed as the end stop accordingly permits particularly flexible adaptation of the active length of the threaded rod to the respective circumstances for the steering column in the respective motor vehicle.

The threaded rod is particularly preferably merely cut to size for different steering columns and then the sleeve is pressed on without further reworking of the threaded rod. Accordingly, no further processing, and in particular no machining, such as the turning of the end region of the threaded rod, takes place in order to be able then to use said rod. It is also possible to omit calking of the sleeve as a stop on the threaded rod. This makes it possible to achieve a cost-effective and simple formation of the adjustment unit and of the steering column which can be adapted in a simple manner to the different geometrical circumstances in a motor vehicle such that defined adjustment ranges can be set.

The sleeve is preferably cut to size from a tubular semi-finished product or hollow profile, preferably from a soft metallic tube. Soft in this case means that the sleeve is less hard than the threaded rod. Since such a semi-finished product can be supplied in a simple manner, a flexible and respectively appropriate end stop, which can be produced in a simple manner, can be obtained for the respective steering column in a motor vehicle without complicated material processing having to be carried out.

The sleeve is preferably designed as a soft steel tube, and therefore the plastic deformation occurs primarily or completely in the sleeve, but not on the threaded rod. Accordingly, the threaded rod can also be adapted retrospectively to the respective circumstances via a displacement of the end stop.

However, the sleeve may also be composed of a plastic in order to achieve stop damping as the threaded rod approaches the stop formed by the sleeve, and to minimize sound emission. A combination of a metallic sleeve with a plastic is also possible.

In order even better to be able to connect the sleeve to the external thread of the threaded rod, the sleeve preferably comprises, on the inner side thereof, one or more projections which can be formed, for example, by teeth or a knurled portion. During the pressing onto the threaded rod, said projections enter into engagement with the external thread and therefore form a form-locking connection, in addition to the force-fitting connection. The sleeve together with the projections or teeth arranged on the inner side can be provided as an extruded profile.

### BRIEF DESCRIPTION OF THE FIGURES

Preferred further embodiments and aspects of the present invention are explained in more detail by the description below of the figures, in which:

FIG. 1 shows a schematic perspective illustration of a steering column having electrical adjustment;

FIG. 2 shows the steering column from FIG. 1 in a schematic perspective side view;

FIG. 3 shows the steering column from FIG. 1 in a further schematic perspective side view;

FIG. 4 shows a first embodiment of an adjustment drive for a steering column according to the abovementioned figures in an exploded illustration;

FIG. 5 shows a schematic perspective illustration of a further embodiment of an adjustment drive;

FIG. 6 shows a schematic perspective illustration of yet another embodiment of an adjustment drive;

FIG. 7 shows a schematic cross-sectional view through a sleeve; and

FIG. 8 shows a schematic longitudinal sectional view through sleeve and threaded rod prior to assembly.

### DETAILED DESCRIPTION OF PREFERRED EXEMPLARY EMBODIMENTS

Preferred exemplary embodiments are described below with reference to the figures. Identical, similar or identically acting elements in the various figures are denoted here by identical reference signs and a detailed description of said elements is partially dispensed with in the description below in order to avoid redundancy.

FIG. 1 shows a steering column 1 which comprises a supporting unit 10 which is connectable to the chassis of a motor vehicle (not shown here) and on which an adjusting unit 16 is held adjustably. The supporting unit 10 comprises a bracket 100 which can be fastened to the chassis of the motor vehicle, for example via fastening bores 102.

The adjusting unit 16 comprises a casing tube 12 in which a steering spindle 14 is rotatably mounted. A steering wheel (not shown here) can be fastened to the steering-wheel-side end 141 of the steering spindle 14. The steering spindle 14 serves to transmit a steering torque introduced to the steering spindle 14 by a driver via the steering wheel to a steerable wheel (not shown here) in a known manner. The steering spindle 14 can transmit the steering movement form the steering wheel to the steerable wheel with the interconnection of a steering mechanism, optionally with the aid of power assistance.

In a variant, the steering movement can also be sensorially sensed, for example electrically, electronically or magnetically, by the steering spindle 14 and fed into a controller which, with the aid of a steering device, executes a pivoting of the steerable wheel in order to provide the steering movement. Systems of this type are known as steer-by-wire.

The casing tube 12 is held in a supporting tube 104 so as to be displaceable in a longitudinal adjustment direction X, wherein the longitudinal adjustment direction X extends in the axial direction of the steering spindle 14. By means of an adjustment of the casing tube 12 in relation to the supporting tube 104, a longitudinal adjustment of the steering spindle 14, and therefore of the steering wheel (not illustrated) can be correspondingly achieved in order to adapt the position of the steering wheel to the seat position of a driver of the motor vehicle.

The supporting tube 104 is fastened pivotably to the bracket 100 and can be pivoted in relation to the bracket 100 about a pivot axis 106. An adjustability of the adjusting unit 16 in a height adjustment direction Z, which is oriented substantially perpendicularly to the longitudinal adjustment direction X, is furthermore made possible by the fact that the casing tube 12 is held on the bracket 100 via pivoting mechanism 18. A pivotability of the casing tube 12 and of the steering spindle 14 in relation to the supporting unit 10, and in particular in relation to the bracket 100 is therefore produced about the pivot axis 106 in such a manner that a height adjustment of the steering wheel (not shown here) arranged on the steering spindle 14 is also achieved in order thereby to adapt the position of the steering wheel to the seat position of the driver.

In the exemplary embodiment, the separate adjustment drive 2, 2′ in each case having a separate adjustment mechanism, comprising a threaded rod 4, 4′, and a spindle nut 3, is provided for each of the two adjustment directions.

An adjustment drive 2 is provided, by means of which the adjusting unit 16 can be adjusted in the longitudinal adjustment direction X in relation to the supporting unit 10. The adjustment drive 2 comprises a threaded rod 4 which is connected to the casing tube 12 via an articulation lever 120. The articulation lever 120 is guided displaceably in a slot 110 in the supporting tube 104 in such a manner that a displacement of the articulation lever 120 in relation to the supporting tube 104 leads to a displacement of the adjusting lever 16 in relation to the supporting unit 10.

The threaded rod 4 is held on the articulation lever 120 and extends in the longitudinal adjustment direction X. The threaded rod 4 is also held in a spindle nut 3 which comprises an internal thread 32 which is in engagement with the external thread of the threaded rod 4. The spindle nut 3 is mounted in a gearing housing 34 in a rotatable but positionally fixed manner with respect to the supporting tube 104, and therefore a rotation of the spindle nut 3 leads, because of the threaded engagement with the threaded rod 4 to an axial movement of the threaded rod relative to the spindle nut 3. In other words, by rotation of the spindle nut 3, a relative movement takes place between casing tube 12 and supporting tube 104 in such a manner that an adjustment of the position of the adjusting unit 16 in relation to the supporting unit 10 is brought about by the rotation of the spindle nut 3.

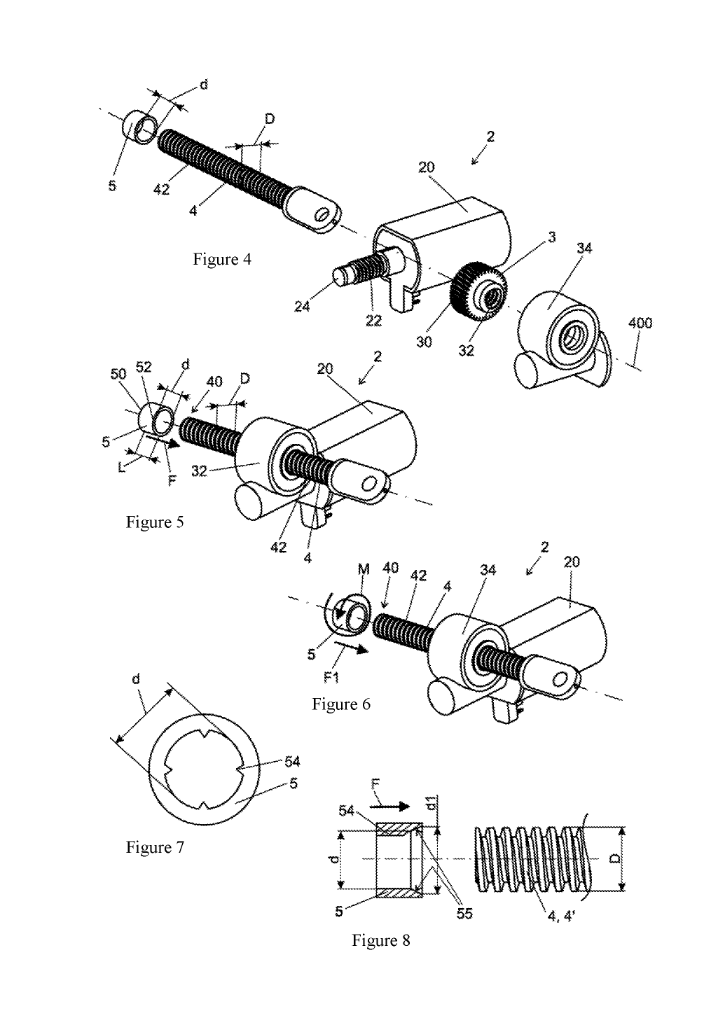

The adjustment drive 2 furthermore comprises a drive motor 20, on the output shaft 24 of which a worm shaft 22 which can be readily seen in FIG. 4 is arranged. The worm shaft 22 engages in an external toothing 30 of the spindle nut 3, wherein the external toothing 30 is designed as a worm wheel. The axis of rotation of the worm shaft 22 and the axis of rotation of the spindle nut 3 are perpendicular to each other, as is known per se in the case of a worm gearing.

Accordingly, by rotation of the output shaft 24 of the drive motor 20, the spindle nut 3 can be rotated, as a result of which a longitudinal adjustment takes place in the longitudinal adjustment direction X of the adjusting unit 16 in relation to the supporting tube 104 and therefore a displacement of the adjusting unit 16 in relation to the supporting unit 10 takes place.

For an adjustment system of this type, it is also conceivable and possible to rotate the threaded rod and to thereby then displace a spindle nut which is secured non-rotatably in relation thereto. In this case, the spindle nut would then be connected to the casing unit in order to transmit the displacement of the spindle nut to the casing unit. This is illustrated in the figures using the example of the height adjustment.

A corresponding adjustment drive 2′ can be seen particularly readily in FIG. 3. Said further adjustment drive 2′ has in principle the same design as the first adjustment drive 2. The further adjustment drive 2′ drives an adjustment movement of the adjusting unit 16 in the height adjustment direction Z. A spindle nut 3′ is displaced in the axial direction via the rotation of a threaded rod 4′. The spindle nut 3′ is connected via a joint 182 to an adjusting lever 181. The adjusting lever 181 is pivotable in a joint axis 183 on the supporting tube 104 and in a joint axis 184 on the bracket 100. The effect achieved by this is that the spindle nut 3′ via the threaded rod 4′ applies a corresponding adjustment to the pivoting mechanism 18 and therefore to the adjusting unit 16 and the supporting tube 104. For a required compensation of length, a corresponding compensating function is integrated in one of the joints. In the example, this is represented by a bolt which forms the pivot axis 106 being accommodated in the bracket in an elongated hole.

FIG. 4 shows the adjustment drive 2 once again in a schematic, perspective and exploded view. The drive motor 20 can be seen with the output shaft 24 on which the worm shaft 22 is formed. The worm shaft 22 is in engagement with external toothing 30 of the spindle nut 3, which external toothing is designed as a worm wheel. The spindle nut 3 is held in the gearing housing 34 in a positionally fixed manner so as to be rotatable about the axis 400 of the threaded rod 4. The spindle nut 3 is mounted non-displaceably here relative to the supporting tube 104 in the direction of the axis 400 of the threaded rod 4. The threaded rod 4 is in engagement by means of its external thread 42 with the internal thread 32 of the spindle nut 3. The gearing housing 34 accordingly ensures that, by rotation of the spindle nut 3, the threaded rod 4 which is in engagement therewith, can be displaced in the direction of the axis 400 of the threaded rod 4.

In order to be able to limit the adjustment travel of the adjustment drive 2 and in particular in order to be able to limit the movement of the threaded rod 4, 4′ with respect to the spindle nut 3, in order to be able to adapt the respective steering column 1 to the installation conditions in the respective type of motor vehicle, the adjustment travel is limited by an end stop. The end stop is formed by a sleeve 5 pressed onto the threaded rod 4. The spindle nut 3 accordingly runs counter to a front end 52 of the sleeve 5 such that the adjustment travel of the adjustment drive 2 is thereby limited.

The sleeve 5 is pressed onto the threaded rod 4 in an end portion 40 of the threaded rod 4. The threaded rod 4 is not processed differently in the end portion 40 than in the remaining regions of the threaded rod 4. In particular, in the end portion 40, said threaded rod likewise has an external thread 42 which extends as far as the end of the threaded rod 4.

The thread rod 4 can be correspondingly formed by simple cutting to size from a longer threaded rod and therefore does not require any further or special processing of the end portion 40 onto which the sleeve 5 is intended to be pressed as the end stop.

Prior to the pressing-on, the sleeve 5 has a smaller inside diameter d than the nominal diameter D of the threaded rod 4. Accordingly, the sleeve 5 is pressed onto the external thread 42 of the threaded rod 4 in the end region 40 by the axial pressing-on shown schematically in FIG. 5 or 8 by the arrow F. During the pressing-on, plastic deformation of the sleeve 5 takes place which is either an elastic deformation or, particularly preferably, a plastic deformation. Quality assurance of the connection can also be produced by measuring the pressing-on force F. In this way, the sleeve 5 can be applied as an end stop on the threaded rod 4 without processing of the threaded rod 4 being required, in particular without turning of the threaded rod 4 or a complicated provision of form-fitting means for the end stop. The sleeve 5 can on the contrary be applied universally to any threaded rod 4 which has a corresponding nominal diameter D which is compatible with the inside diameter d of the sleeve 5. The sleeve 5 can therefore also be applied as an end stop to the threaded rod 4 irrespective of the pitch and the number of turns of the external thread 42.

The sleeve advantageously has an insertion bevel or an insertion cone 55 which forms an insertion opening having the opening diameter d1, wherein the opening diameter d1 is larger than the nominal diameter D of the threaded rod 4 or of the threaded rod 4′. The pressing-on of the sleeve 5 is facilitated by the insertion cone 55. For the force fit, the projections 54 also permit an additional form fit for connecting the sleeve 5 to the threaded rod 4 or the threaded rod 4′.

As is apparent and can be gathered directly from FIG. 8, the invention can be used both on adjustment drives with a rotatable spindle nut 3 and on adjustment drives with a rotatable threaded spindle 4′.

In addition to the axial pressing-on with a force F shown in FIG. 5, the sleeve 5 can also be applied to the threaded rod along the pressing-on movement, which is shown schematically by the arrow M in FIG. 6 and comprises a rotation, with a force F1 with a torque being applied. In this manner, in the event of relatively soft materials of the sleeve 5, the external thread 42 of the threaded rod 4 can be formed into the inner surface of the sleeve 5.

The sleeve 5 can have a length L which is selected in such a manner that the rear end 50 of the sleeve 5 substantially ends with the end surface of the rear end 40 of the threaded rod 4, wherein the front end 52 of the sleeve 5 is then provided in the desired position as an end stop in order thereby to limit the movement of the threaded rod 4 with respect to the spindle nut 3.

However, in a further embodiment, the sleeve 5 can have a constant length L for a multiplicity of different use options. The sleeve can be positioned freely along the length of the threaded rod 4 in order, with its front end 52, to provide the desired end stop in a predetermined position.

The sleeve 5 is accordingly a tubular sleeve which does not have a closed surface at its rear end 50. In a preferred embodiment in which the length L of the sleeve 5 is set in accordance with the respective use form, an end surface may, however, also be present here such that the sleeve 50 then forms the shape of an end cap.

In the cross-sectional view of the sleeve 5 shown schematically in FIG. 7, said sleeve in turn has an inside diameter d which, depending on the embodiment, is smaller or larger than the nominal diameter D of the threaded rod 4. Furthermore, teeth 54 are provided which extend along the sleeve axis on the inner side of the sleeve 5. The teeth 54 engage with the external thread 42 of the threaded rod 4 when the sleeve 5 is pressed onto the threaded rod 4.

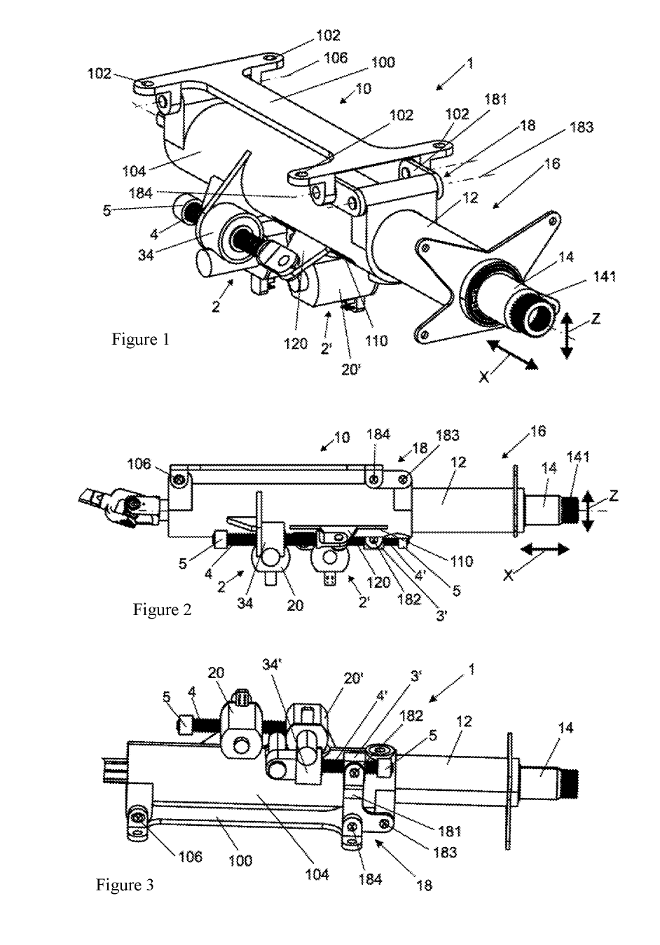

FIG. 8 schematically illustrates a view in longitudinal section through the sleeve 5, in the example with the toothings 54 and an insertion cone 55, prior to the pressing onto the threaded rod 4, which is not mounted rotatably, in accordance with FIGS. 1 to 6, or onto the rotatably mounted threaded rod 4′ in accordance with FIGS. 2 and 3. It becomes clear here that the same sleeve is suitable for both embodiments of the adjustment drive 2, 2′.

The sleeve 5 can be correspondingly pressed onto the external thread 42 of the threaded rod 4, wherein the inside diameter d of the sleeve 5 is smaller than the nominal thread diameter D of the threaded rod 4. The sleeve 5 is pressed axially onto the threaded rod 4.

In an alternative embodiment, the sleeve 5 comprises, on its inner side, teeth 54 which, during the pressing onto the external thread 42 of the threaded rod 4, are embedded in the turns of the external thread 42, wherein the inside diameter d of the sleeve 5 is larger than the nominal thread diameter D of the threaded rod 4 and therefore only the teeth 54 of the sleeve 5 are in contact with the external thread 42 of the threaded rod 4. By this means, the stability of the sleeve 5 against rotation can be further improved, and therefore, in the event of repeated striking of the spindle nut against the end stop formed by the sleeve 5, loosening of the sleeve 5 can be reduced or prevented.

For the pressing of the sleeve 5 with teeth 54 onto the threaded rod 4, it may be advantageous if the hardness, at least the surface layer hardness, of the sleeve 5 is greater than the hardness of the threaded spindle 4.

The sleeve 5 is preferably cut to size from a steel tube, hollow profile or extruded profile, and therefore the sleeve 5 can be formed cost-effectively and in a manner adapted to the respective intended use. Preferred examples of the semi-finished product from which the sleeve 5 can be cut to size are the following steel tubes:
EN 10305-1—235+N with an outside diameter of 12 mm and a wall thickness of 1.2 mm
EN 10305-1—235+A with an outside diameter of 12 mm and a wall thickness of 1.2 mm
EN 10305-1—215+N with an outside diameter of 12 mm and a wall thickness of 1.2 mm
EN 10305-1—215+A with an outside diameter of 12 mm and a wall thickness of 1.2 mm

The sleeve 5 can be used in a modular manner here and is in particular independent of the thread pitch of the respective threaded rod 4 and also of the number of turns of the external thread 42.

To the extent useable, all of the individual features which are illustrated in the individual exemplary embodiments can be combined and/or interchanged with one another without departing from the scope of the invention.

### LIST OF REFERENCE SIGNS

1 Steering column

10 Supporting unit

12 Casing tube

14 Steering spindle

141 Steering-wheel-side end

16 Adjusting unit

18 Pivoting mechanism

100 Bracket

102 Fastening bore

104 Supporting tube

106 Pivot axis

110 Slot

120 Articulation lever

181 Adjusting lever

182 Joint

183 Joint axis

184 Joint axis

2 Adjustment drive

2′ Adjustment drive

20 Drive motor

20′ Drive motor

22 Worm shaft

24 Output shaft

3 Spindle nut

30 External toothing

32 Internal thread

34 Gearing housing

4 Threaded rod

4′ Threaded rod

40 End portion

42 External thread

400 Axis of the threaded rod

5 Sleeve

50 Rear end of the sleeve

52 Front end of the sleeve

54 Tooth

X Longitudinal adjustment direction

Z Height adjustment direction

d Inside diameter of the sleeve

d1 Opening diameter of the sleeve

D Nominal diameter of the threaded rod

F, F1 Pressing-on force

L Length of the sleeve

M Pressing-on movement (torque)

1.-10. (canceled)

11. A steering column for a motor vehicle, comprising:
a supporting unit that is connectable to the chassis of the motor vehicle;
an adjusting unit coupled to said supporting unit;
a steering spindle disposed and rotatably supported in said adjusting unit; and
an adjustment drive coupled between said supporting unit and said adjusting unit and configured to adjust a position of the adjusting unit in relation to the supporting unit, said adjustment drive comprising,
a spindle nut having internal threads defined therein,
an threaded rod having external threads in engagement with said internal threads of said spindle nut, and
an end stop disposed at a first end of said threaded rod, said end stop formed by a sleeve pressed onto said external threads of said threaded rod, said end stop being configured to limit an axial movement of said spindle nut along said threaded rod.

12. The steering column of claim 11, wherein an inside diameter of said sleeve, prior to being pressed onto said threaded rod, is smaller than a nominal diameter of said threaded rod.

13. The steering column of claim 11, wherein said sleeve is configured to plastically deform when pressed onto said threaded rod.

14. The steering column of claim 11, wherein said sleeve is configured to elastically deform when pressed onto said threaded rod.

15. The steering column of claim 11, wherein said sleeve is configured to be pressed onto said external threads of said threaded rod in an axial direction of said threaded rod.

16. The steering column of claim 11, wherein said sleeve is configured to be pressed onto said external threads of said threaded rod together with a rotational movement about a longitudinal axis of said threaded rod.

17. The steering column of claim 11, wherein said sleeve is configured to be freely positionable along a length of said threaded rod.

18. The steering column of claim 11, wherein said sleeve is made from at least one of a metallic tube or plastic.

19. The steering column of claim 11, wherein said sleeve comprises at least one tooth disposed on an inner surface of said sleeve that is in engagement with said external threads of said threaded rod.
